(19) United States
(12) Patent Application Publication
(10) Pub. No.: US 2016/0132520 A1
(43) Pub. Date: May 12, 2016

(54) METHOD AND APPARATUS FOR FINDING FILE IN STORAGE DEVICE AND ROUTER

(71) Applicant: Xiaomi Inc., Beijing (CN)

(72) Inventors: Xianlin CHEN, Beijing (CN); Zheng Li, Beijing (CN); Tiejun LIU, Beijing (CN)

(73) Assignee: Xiaomi Inc., Beijing (CN)

(21) Appl. No.: 15/000,164

(22) Filed: Jan. 19, 2016

Related U.S. Application Data
(63) Continuation-in-part of application No. PCT/CN2015/074437, filed on Mar. 18, 2015.

(30) Foreign Application Priority Data
Aug. 15, 2014 (CN) 201410404053.X

(51) Int. Cl. G06F 17/30

(52) U.S. Cl. CPC G06F 17/30097; G06F 17/30598; G06F 17/30203; G06F 17/30327

(57) ABSTRACT

The present disclosure relates to a method and an apparatus for finding a file in a storage device, and a router. The method includes: establishing an index for a specified file in the storage device according to file classifications or an identification of a device that uploaded the file, the storage device being a storage device configured in the router; and providing a classification view of the specified file for a user device, the classification view including identifications of the respective file classifications. The present disclosure provides the classification of the specified file for the user device by according to file types or the identification of the device for uploading the file, so that different user devices may more flexibly perform classification finding when viewing files in the storage device of the router, whereby it is convenient for a user to find the file, the operation is simple and efficient, and the user's experience is good.

### PRIORITY STATEMENT

The present disclosure is a continuation-in-part of International Application No. PCT/CN2015/074437, filed on Mar. 18, 2015, which is based upon and claims priority to Chinese Patent Application No. 201410404053.X, filed on Aug. 15, 2014, the entire contents of which are incorporated herein by reference.

### TECHNICAL FIELD

The present disclosure relates to a field of Internet technology, and more particularly to a method and an apparatus for finding a file in a storage device, and a router.

### BACKGROUND

A router is a networking device that forwards data packets between computer networks. A router is connected to two or more data lines from different networks (as opposed to a network switch, which connects data lines from one single network). Nowadays, in addition to having basic routing and forwarding functions, a router is slowly transforming to become a family data center. A user begins to back up data of a device, such as a mobile phone, a camera and the like, to the router to realize data sharing.

In the related art, the router realizes data sharing through Samba, a software re-implementation of SMB/CIFS networking protocol. When data is shared through the Samba, a data file is displayed according to a directory structure in the router. When browsing a file on the router, the user must know a path of the file, and then enter into the directory level by level to find it, whereby the operation is quite cumbersome.

### SUMMARY

In order to overcome the problems of the complicated operation existing in the related art as introduced above, the present disclosure provides a method and an apparatus for finding a file in a storage device, and a router.

According to an aspect of the present disclosure, a router may comprise a storage medium comprising a set of instructions for finding a file; and a processor in communication with the storage medium. When executing the set of instructions, the processor is directed to connect to two or more data lines between a plurality of networks to forward data packets between the plurality of networks; connect to a storage device; establish an index for a specified file in the storage device according to a classification; and provide information of the specified file to a user device with a classification view showing the classification of the specified file.

According to another aspect of the present disclosure, a method for finding a file in a storage device using a router may comprise establishing, by the router, an index for a specified file in the storage device according to a classification; and providing, by the router, information of the specified file to a user device with a classification view showing the classification of the specified file, wherein the classification comprises classifying a file according to file types or an identification of a device from which the file was uploaded, and wherein the router is configured to connect to two or more data lines between a plurality of networks to forward data packets between the plurality of networks.

According to yet another aspect of the present disclosure, a non-transitory processor-readable storage medium may comprise a set of instructions for directing a router to find a file in a storage device, wherein when executing by the router the set of instructions directs the router to perform acts of: connecting the router to a storage device; establishing an index for a specified file in the storage device according to a classification; and providing information of the specified file to a user device with a classification view showing the classification of the specified file, wherein the user device is in communication with the router and the classification comprises classifying a file according to file types or an identification of a device from which the file was uploaded.

The technical solutions provided by the embodiments of the present disclosure may include the following advantageous effects: by establishing an index for a specified file in the storage device according to file classifications which are divided according to file types or an identification of a device for uploading the file; and providing a classification view of the specified file for a user device, the classification view including identifications of the respective file classifications, the file finding manner is combined with the storage device of the router, so that different user devices may more flexibly perform a classification finding when viewing the file in the storage device of the router, for example, different user devices may classify according to file types and file source, whereby it is convenient for the user to find the file in the storage device of the router, the operation is simple and efficient, and the user's experience is good.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is an application scenarios diagram illustrating a method for finding a file in a storage device according to an exemplary embodiment;

FIG. 2 is a flow chart illustrating a method for finding a file in a storage device according to an exemplary embodiment;

FIG. 3 is a flow chart illustrating a method for finding a file in a storage device according to another exemplary embodiment;

FIG. 4 is a diagram illustrating a terminal interface when a finding begins according to another exemplary embodiment;

FIG. 5 is a diagram illustrating another terminal interface when a finding begins according to another exemplary embodiment;

FIG. 6 is a diagram illustrating a terminal interface after a classification finding begins according to another exemplary embodiment;

FIG. 7 is a diagram illustrating a terminal interface after a directory finding begins according to another exemplary embodiment;

FIG. 8 is a diagram illustrating a terminal interface when a search finding begins according to another exemplary embodiment;

FIG. 9 is a block diagram illustrating an apparatus for finding a file in a storage device according to an exemplary embodiment;

FIG. 10 is a block diagram illustrating an apparatus for finding a file in a storage device according to another exemplary embodiment; and

FIG. 11 is a block diagram illustrating an apparatus for finding a file in a storage device according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

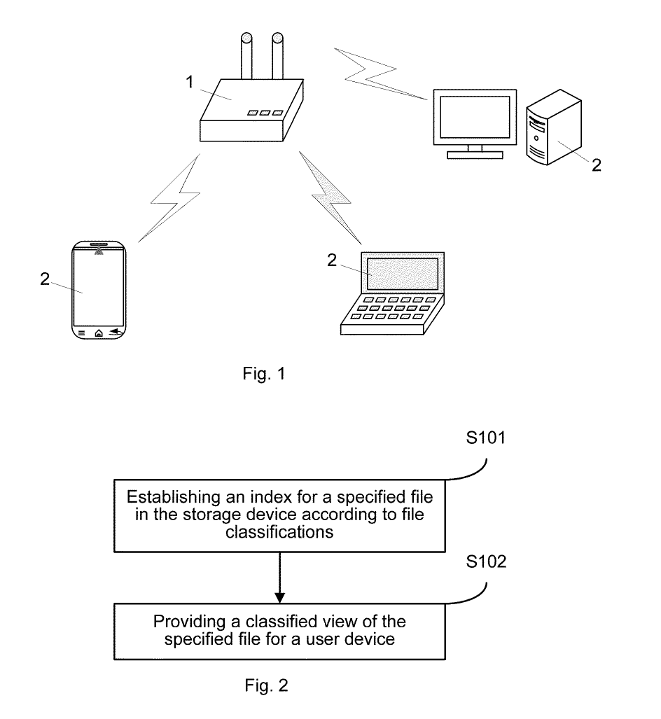

FIG. 1 is an application scenarios diagram illustrating a method for finding a file in a storage device according to an exemplary embodiment. As shown in FIG. 1, a storage device 1 is wired or wireless connected with several terminal devices 2 respectively, so as to form a LAN (Local Area Network). The storage device 1 is a data center of the LAN, the terminal device 2 may transfer data to the storage device 1 for backup and sharing. Herein, the storage device 1 may be configured in the router or other storage devices with computation function, and the terminal device 2 may be a mobile phone, a notebook computer, a table computer, and the like. The present disclosure is not limited thereto.

The storage device 1 may function as a router in the LAN. For example, the storage device 1 may connect to another network, such as Internet external to the LAN and forward data packets between the terminal devices 2.

It should be noted that, the application scenario shown in FIG. 1 is only an example, and the present disclosure is not limited thereto.

FIG. 11 illustrates a block diagram illustrating an apparatus 1900 for finding a file in a storage device according to an exemplary embodiment. The apparatus 1900 may serve as the storage device 1 in FIG. 1. The apparatus 1900 may include a processing component 1922 that further includes one or more processors, and memory resources represented by a storage medium (e.g., a memory) 1932 for storing instructions, such as application programs, executable by the processing component 1922. The application programs stored in memory 1932 may include one or more modules, each of which corresponds to a set of instructions that implement methods described in the present disclosure. Moreover, the processing component 1922 (e.g., the processors of the processing component 1922) may be configured to execute instructions for performing the above described method.

The apparatus 1900 may also include a power component 1926 configured to perform power management of the apparatus 1900, wired or wireless network interface(s) 1950 configured to connect the apparatus 1900 to a network, and an input/output (I/O) interface 1958. The apparatus 1900 may operate based on an operating system stored in the memory 1932, such as Windows Server™, Mac OS X™, Unix™, Linux™ FreeBSD™, or the like.

When the processing component 1922 executes the application programs to serve as a router in the LAN in FIG. 1, the apparatus 1900 may connect the LAN to another network, such as Internet, or a plurality of networks external to the LAN and forward data packets between the terminal devices 2.

FIG. 2 is a flow chart illustrating a method for finding a file in a storage device according to an exemplary embodiment, which is applied in a router. The method may be implemented in a router, such as the apparatus 1900, in a network environment, such as the LAN in FIG. 1. For example, the method may be implemented in a set of instructions stored in the storage medium of the apparatus 1900 and may be executed by the processor of the apparatus 1900. When the apparatus serves as a router, the set of instructions may direct the processor to connect to two or more data lines between a plurality of networks to forward data packets between the plurality of networks. Further, the method may include the following steps.

In step S101, establishing an index for a specified file in the storage device according to file classifications.

In the present embodiment, the files are classified according to file types or an identification of a device for uploading the file. File types may include one or more of a picture, an audio, a video and a textual file. The storage device may be the storage medium in the router and/or an external storage device in communication with the router.

Step S101 may be performed when the storage device starts, or may also be performed when the file in the storage device is updated, and the present disclosure is not limited thereto.

In step S102, providing to a user device a classification view of the specified file.

The user device may be an electronic device, such as a computer, a mobile terminal (e.g., a mobile phone, tablet computer, PDA etc.), and other types of electronic device, such as a printer and/or a scanner, in communication with the router via the network. In the present embodiment, the classification view may include an identification of the classification of each file. When the file is classified according to file types, the identifications of the file classifications are identifications of file types, for example, the picture, the audio, the video and the text. When the file is classified according to the identification of the device from which the file was uploaded, the identifications of the file classifications are the identification of the device that uploaded the file.

The embodiments of the present disclosure establishes an index for a specified file in the storage device according to file classifications which are divided according to file types or an identification of a device for uploading the file; and provides a classification view of the specified file for a user device, the classification view including identifications of the respective file classifications, the file finding manner is combined with the storage device of the router, so that different user devices may more flexibly perform a classification finding when viewing the file in the storage device of the router, for example, different user devices may classify according to file types and file source, whereby it is convenient for the user to find the file in the storage device of the router, the operation is simple and efficient, and the user's experience is improved.

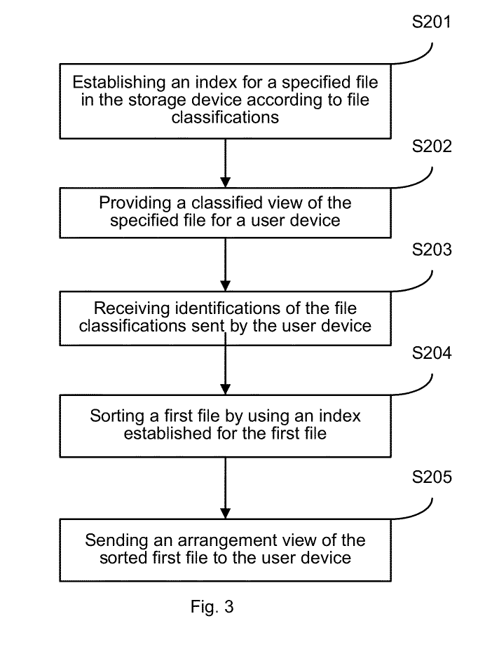

FIG. 3 is a flow chart illustrating a method for finding a file in a storage device according to another exemplary embodiment. The method may be implemented in a router, such as the apparatus 1900, in a network environment, such as the LAN in FIG. 1. For example, the method may be implemented in a set of instructions stored in the storage medium of the apparatus 1900 and may be executed by the processor of the apparatus 1900. When the apparatus serves as a router, the set of instructions may direct the processor to connect to two or more data lines between a plurality of networks to forward data packets between the plurality of networks. For example, as shown in FIG. 1, the router may be in communication with a plurality of terminal devices 2. The terminal devices 2 may be able to upload files to or download files from a storage device via the router. The storage device may be the storage medium in the router and/or an external storage device in communication with the router. Further, the method may include the following steps.

In step 201, establishing an index for a specified file in the storage device according to file classifications.

In the present embodiment, the file classifications may be predetermined file classifications; and the storage device may store a plurality of files uploaded from the plurality of terminal devices via the router. The files that are saved in the storage device may be classified according to file types or an identification of the terminal device from which the files are uploaded to the storage device. File types may include one or more of a picture, an audio, a video and a textual file. The identification of the device for uploading the file may include one or more of a number of the device, a name of the device and a type of the device. The storage device is a storage device configured in the router.

Step S102 may be performed when the storage device starts, or may also be performed when the file in the storage device is updated, the present disclosure is not limited thereto.

The specified file may be all files in the storage device, or may also be a file in a directory specified by a user or a memory, such as a file uploaded by a user device (i.e., a terminal device), and the present disclosure is not limited thereto. A database may be specially established to save the established index of the files.

In an implementation of the present embodiment, the step S201 may include:

Acquiring information of the specified file which includes one or more of a path of the file, a hash value of the file, a name of the file, a multipurpose Internet mail extensions (referred to as MIME) type of the file, a creation date of the file, a modification time of the file, an identification of the user device, a size of the file and a thumbnail of the file; and

Establishing the index respectively for the specified file corresponding to the respective file types and the identification of the device for uploading the file according to the information of the specified file.

In step S202, providing the specified file to a user device with a view of the specified file.

The classification view may be a way showing the specified file with a view of tree-structured classification. In the present embodiment, files in the router may be classified into a tree-structured taxonomy. The classification view may include an identification of the classification of each file. When the file is classified according to file types, the identification of the file classifications are identifications of file types, for example, the picture, the audio, the video and the text. When the file is classified according to the identification of the device for uploading the file, the identifications of the file classifications are the identification of the device for uploading the file. The router may obtain information of the specific file, including classification of the specific file, from the storage device and send the information to the user terminal in a format to direct the user terminal to display the information under a classification view, wherein under the classification view the terminal device displays the information of the specified file according to its classification information.

In an implementation of the present embodiment, the step S202 may include:

Receiving a file finding request sent by the user device; and

Sending the classification view to the user device.

In another implementation of the present embodiment, step S202 may include:

Receiving a file finding request sent by the user device;

Sending a search option to the user device, the search option including finding the file via classification, via search or via a directory. Here, the classification finding may be a search option that allows a user to search a file based on its classification. The classification may be any times of classification that organized the files under a tree structure. The search finding may be a search option that allows the user to search a file based on a search query. Under the search finding, a user may input a search query in the router and find all files saved therein related to the search query. The directory finding may be a search option that allows the user to search a file based on directory (e.g., path) of the file.

Receiving the finding manner sent by the user device; and

Sending the classification view to the user device when the finding manner sent by the user device is the classification finding.

According to an implementation, the storage device may install a Web server program, the Web server program may provide to the user device an interface to display the information of the specified file by way of http (Hypertext Transfer Protocol), including the options of the classification view, the finding manner and the like of the specified file for the user device.

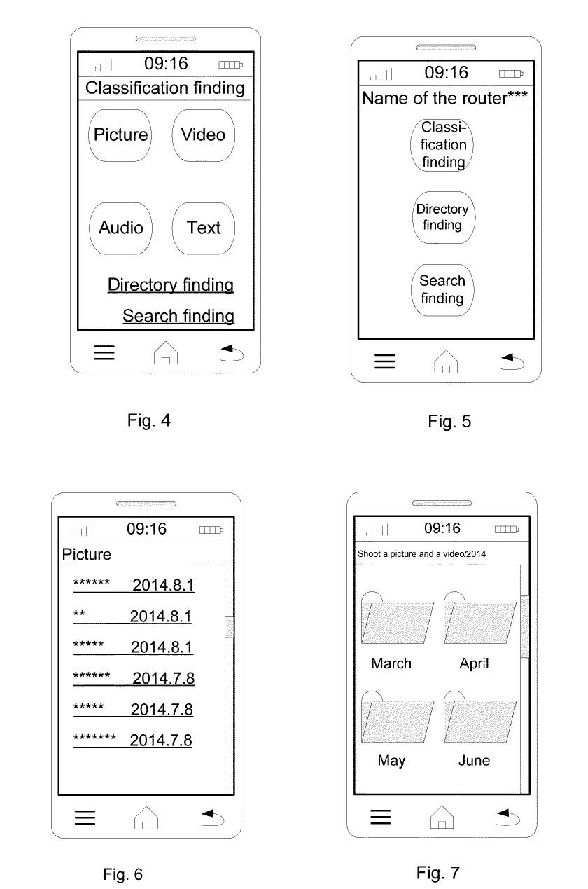

The classification finding may be used as a default finding manner, the classification view is directly sent to the user device after receiving the file finding request sent by the user device, meanwhile, the option switched to the directory finding or the search finding may also be provided, as shown in FIG. 4. The option of the finding manner may also be sent to the user device after receiving the file finding request sent by the user device, as shown in FIG. 5.

In step S203, receiving a file classification identification from the user device.

In step S204, determining a first plurality of files using the received file classification identification, and sorting the first plurality of files using an index established for the first plurality of files.

In the present embodiment, the first plurality of files is the specified files corresponding to the file classification identification sent by the user device.

In an implementation of the present embodiment, step S204 may include:

Sorting the first plurality of files according to the creation time of the first plurality of files when the first plurality of files is a picture;

Sorting the first plurality of files according to the name of the first plurality of files when the first plurality of files is an audio;

Sorting the first plurality of files according to the creation time of the first plurality of files when the first plurality of files is a video; and

Sorting the first plurality of files according to a modification time of the first plurality of files when the first plurality of files is a text.

It is understood that, the picture is generally a photograph shoot by the user, the video is generally an image shoot by the user. In general, the shooting time (i.e., the creation time of the file) of the photograph and the image shoot for the same place, the same event or the same purpose is adjacent, and thus when the picture and the video are found, the file is arranged according to the creation time of the file (for example, from nearest to farthest), whereby it is convenient for the user to find the file. The audio is generally a user's favorite music. In general, the user uses a name of the music (i.e., the name of the file) to find the audio, and the audio is arranged according to the name of the file (for example, an alphabetical order), whereby it is convenient for the user to find the file. The text (such as pdf, ppt, word, excel, wps) is related to a user's work, and in general, the closer the modification time is, the higher the frequency of the use is. The text is arranged according to the modification time of the file (for example, from nearest to farthest), whereby it is more convenient to use.

In other implementation, a set sequence may also be a sequence preset by the user, and the present disclosure is not limited thereto. According to an implementation, the set sequence may be specified through Structured Query Language (referred to as SQL) statements.

In step S205, an arrangement view of the sorted first plurality of files is sent to the user device.

In the present embodiment, the arranged view of the sorted first plurality of files may be a view of the first plurality of files that is arranged according to the sorted order. The arrangement view of the first plurality of files may include at least a name of the first plurality of files. The arrangement view of the first plurality of files may further include one or more of a multipurpose Internet mail extensions MIME type of the first plurality of files, a size of the first plurality of files, a path of the first plurality of files, a uniform resource locator (referred to as URL) of the first plurality of files, a URL of a thumbnail of the first plurality of files and a creation time of the first plurality of files.

According to an implementation, the user device will actively send the number of the returned information such as the name of the first plurality of files and the like, and the returned location of the information such as the name of the first plurality of files and the like at the beginning, for example, a hundred of the names of the first plurality of files are returned from the beginning of the name of the first plurality of files.

FIG. 6 is a schematic diagram of a terminal interface after executing step S205, which is only an example. The user may click the corresponding part to link to the corresponding file in the storage device.

In a further implementation of the present embodiment, the method may further include:

Receiving the finding manner sent by the user device, the finding manner including the classification finding, the search finding or the directory finding;

When the fining manner is the search finding, finding a second plurality of files using an index established for the second plurality of files, and sending an arrangement view of the first plurality of files to the user device, wherein the first plurality of files is the specified file corresponding to the identification of the device for uploading the file found by the user device;

Sending a directory structure of the specified file to the user device when the finding manner is the directory finding; and

Providing the classification view for the user device when the finding manner is the classification finding.

According to an implementation, when the finding manner sent by the user device is the directory finding, the directory structure of the specified file is sent to the user device, as shown in FIG. 7. It should be noted that, when performing the directory finding, the user may access and find the file level by level from a root directory according to the path of the file. Herein, the directory structure of the picture and the video shoot by the user is classified according to year, month and day in the shooting time.

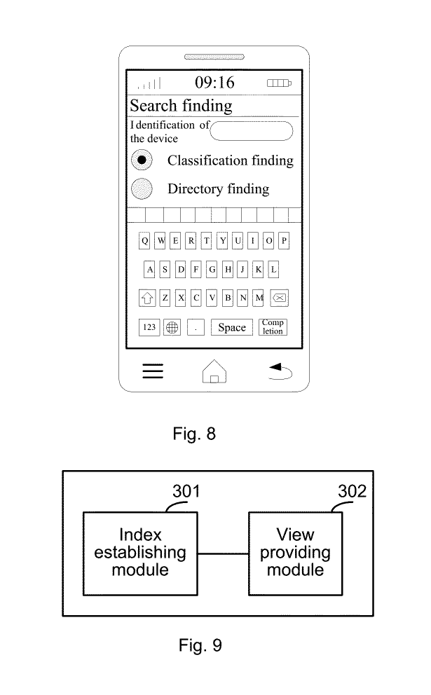

When the finding manner sent by the user device is the search finding, the interface of the identification of the device for uploading the file is provided for the user device, as shown in FIG. 8. When the identification of the device for uploading the file required to be searched is input in an input box, the user may also select the arrangement view of the file through the options of the classification finding and the directory finding.

In a further implementation of the present embodiment, the method may further include:

Monitoring a new added file in the storage device; and

Establishing an index for the new added file according to the file classifications when the new added file is different from the stored file in the storage device.

According to an implementation, whether the new added file is different from the stored file in the storage device may be decided according to the hash value or the identification of the device for uploading the file. Since the hash value is unique and extremely compact numerical representation for a piece of data, the duplicate files are deleted according to the hash value, the use of which is convenient and the reliability is higher. If when the hash value of the new added file is different from the hash value of the stored file in the storage device, or, when the identification of the device for uploading the new added file is different from the identification of the device for uploading the stored file in the storage device, it is decided that the new added file is different from the stored file in the storage device.

When the new added file is the same as the stored file in the storage device, the new added file is deleted, so as to avoid establishing two or more indexes for the same file, thus, the occupation of the physical space and the influence of the index maintenance speed are reduced.

When uploading the new added file, the user device may upload the identification of the device for the storage device. The storage device provides some metadata information through the algorithm supported by the operating system or the file itself, acquires the information of the file from the new added file and the identification of the device for uploading the new added file, and establishes the index for the new added file according to the file classifications.

A file system may be monitored when the storage device is started, for example, an update of the file in the storage device may be known by using an inotify function (which is a system request of Linux), and for example, a backup of the file may be made by the user using Samba, http (Hypertext Transfer Protocol) service.

The embodiments of the present disclosure establishes an index for a specified file in the storage device according to file classifications which are divided according to file types or an identification of a device for uploading the file, and provides a classification view of the specified file for a user device, the classification view including identifications of the respective file classifications. Such the file finding manner is combined with the storage device of the router, so that different user devices may more flexibly perform a classification finding when viewing the file in the storage device of the router, for example, different user devices may classify according to file types and file source, whereby it is convenient for the user to find the file in the storage device of the router, the operation is simple and efficient, and the user's experience is good. And, as for the specified file corresponding to different file types, the arrangement view thereof may be listed according to different orders, thereby finding the file more conveniently, and improving the user's experience. Moreover, the searching and filtering may also be made according to the identification of the device for uploading the file, thereby narrowing the finding range by the user, saving the time found by the user, and further improving the user's experience.

FIG. 9 is a block diagram illustrating an apparatus for finding a file in a storage device according to an exemplary embodiment. The apparatus is applied in the router. Referring to FIG. 9, the apparatus includes an index establishing module 301 and a view providing module 302.

The index establishing module 301 is configured to establish an index for a specified file in the storage device according to file classifications which are divided according to file types or an identification of a device for uploading the file, the storage device being a storage device configured in the router

The view providing module 302 is configured to provide a classification view of the specified file for a user device, the classification view including identifications of the respective file classifications.

The embodiments of the present disclosure establishes an index for a specified file in the storage device according to file classifications which are divided according to file types or an identification of a device for uploading the file; and provides a classification view of the specified file for a user device, the classification view including identifications of the respective file classifications, the file finding manner is combined with the storage device of the router, so that different user devices may more flexibly perform a classification finding when viewing the file in the storage device of the router, for example, different user devices may classify according to file types and file source, it is convenient for the user to find the file in the storage device of the router, the operation is simple and efficient, and the user's experience is good.

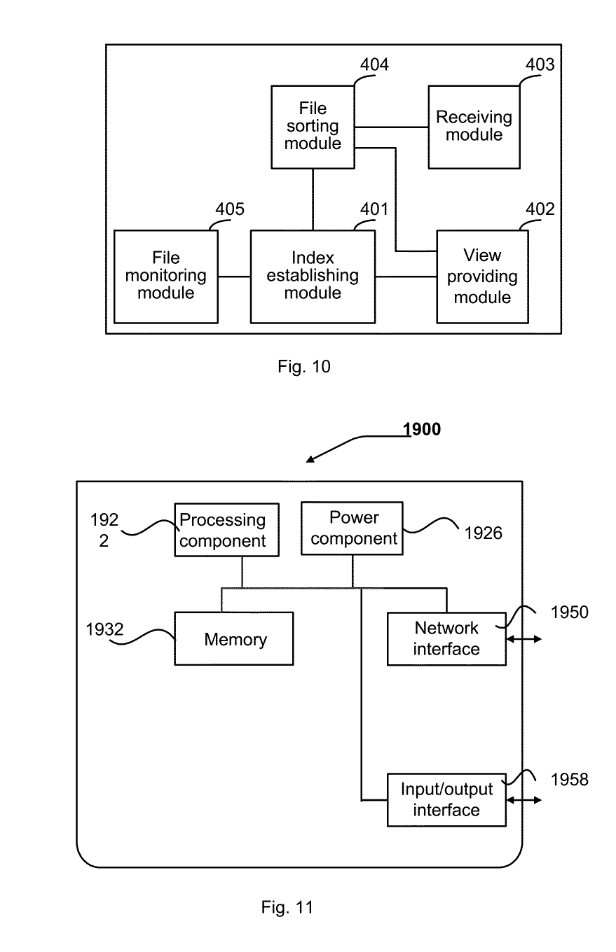

FIG. 10 is a block diagram illustrating an apparatus for finding a file in a storage device according to another exemplary embodiment. The apparatus is applied in the router. Referring to FIG. 10, the apparatus includes an index establishing module 401 and a view providing module 402.

The index establishing module 401 is configured to establish an index for a specified file in the storage device according to file classifications which are divided according to file types or an identification of a device for uploading the file, the storage device being a storage device configured in the router

The view providing module 402 is configured to provide a classification view of the specified file for a user device, the classification view including identifications of the respective file classifications.

In an implementation of the present embodiment, the index establishing module 401 may be configured to:

Acquire information of the specified file which includes one or more of a path of the file, a hash value of the file, a name of the file, a multipurpose Internet mail extensions MIME type of the file, a creation date of the file, a modification time of the file, an identification of the user device, a size of the file and a thumbnail of the file; and

Establish the index respectively for the specified file corresponding to the respective file types and the identification of the device for uploading the file according to the information of the specified file.

In another implementation of the present embodiment, the view providing module 402 may be configured to:

Receive a file finding request sent by the user device; and

Send the classification view to the user device; or

Receive a file finding request sent by the user device;

Send an option of a finding manner to the user device, the finding manner including a classification finding, a search finding or a directory finding;

Receive the finding manner sent by the user device; and

Send the classification view to the user device when the finding manner sent by the user device is the classification finding

In a further implementation of the present embodiment, the apparatus may further include a receiving module 403 and a file sorting module 404.

The receiving module 403 is configured to receive the identification of the file classifications sent by the user device.

The file sorting module 404 is configured to sort a first plurality of files which is the specified file corresponding to the identification of the file classifications sent by the user device, by using an index established for the first plurality of files.

The view providing module 402 is further configured to send an arrangement view of the sorted first plurality of files to the user device, the arrangement view of the first plurality of files including at least a name of the first plurality of files.

According to an implementation, the arrangement view of the first plurality of files may further include one or more of a MIME type of the first plurality of files, a size of the first plurality of files, a path of the first plurality of files, a URL of the first plurality of files, a URL of a thumbnail of the first plurality of files and a creation time of the first plurality of files.

The file sorting module 404 may be configured to:

Sort the first plurality of files according to the creation time of the first plurality of files when the first plurality of files is a picture;

Sort the first plurality of files according to the name of the first plurality of files when the first plurality of files is an audio;

Sort the first plurality of files according to the creation time of the first plurality of files when the first plurality of files is a video; and

Sort the first plurality of files according to a modification time of the first plurality of files when the first plurality of files is a text.

In a further implementation of the present embodiment, the apparatus may further include a receiving module 403.

The receiving module 403 is configured to receive the finding manner sent by the user device, the finding manner including the classification finding, the search finding or the directory finding.

The view providing module 402 is further configured to find a second plurality of files, which is the specified file corresponding to the identification of the device for uploading the file found by the user device, by using an index established for the second plurality of files and send an arrangement view of the second plurality of files to the user device when the finding manner is the search finding; send a directory structure of the specified file to the user device when the finding manner is the directory finding; and provide the classification view for the user device when the finding manner is the classification finding.

In a further implementation of the present embodiment, the apparatus may further include a file monitoring module 405.

The file monitoring module 405 is configured to monitor a new added file in the storage device.

The index establishing module 401 is further configured to establish an index for the new added file according to the file classifications when the new added file is different from the stored file in the storage device.

The embodiments of the present disclosure establishes an index for a specified file in the storage device according to file classifications which are divided according to file types or an identification of a device for uploading the file; and provides a classification view of the specified file for a user device, the classification view including identifications of the respective file classifications, the file finding manner is combined with the storage device of the router, so that different user devices may more flexibly perform a classification finding when viewing the file in the storage device of the router, for example, different user devices may classify according to file types and the source of the file, whereby it is convenient for the user to find the file in the storage device of the router, the operation is simple and efficient, and the user's experience is good. And, as for the specified file corresponding to different file types, the arrangement view thereof may be listed according to different orders, thereby finding more conveniently, and improving the user's experience. Moreover, the searching and filtering may also be made according to the identification of the device for uploading the file, thereby narrowing the finding range by the user, saving the time found by the user, and further improving the user's experience.

With regard to the apparatus in the above embodiment, detailed description of specific manner for performing operation of modules has been made in the embodiments related to the method, and no detailed illustration will be made herein.

After considering this description and carrying out the embodiments disclosed herein, those skilled in the art may easily anticipate other implementation aspects of the present disclosure. The present disclosure is meant to cover any variations, usage or adaptive change of these embodiments, and these variations, usage or adaptive change follow general concept of the present disclosure and include the common knowledge or the customary technical means in the technical field that is not disclosed in the present disclosure. The description and embodiments are only exemplary, and the real range and spirit of the present disclosure are defined by the following claims.

It should be understood that the present disclosure is not limited to precise structures that are described above and shown in the accompanying drawings, and may be modified and changed without departing from the range of the present disclosure. The scope of the present disclosure is only defined by the appended claims.

1. A router, comprising:
a storage medium comprising a set of instructions for finding a file; and
a processor in communication with the storage medium, wherein when executing the set of instructions, the processor is directed to:
connect to two or more data lines between a plurality of networks to forward data packets between the plurality of networks;
connect to a storage device;
establish an index for a specified file in the storage device according to a classification; and
provide information of the specified file to a user device with a classification view showing a tree-structured classification of the specified file.

2. The router according to claim 1, wherein the classification comprises classifying a file according to a file type of the file or an identification of a device from which the file was uploaded.

3. The router according to claim 1, wherein the storage device is a storage device in the router.

4. The router according to claim 1, wherein to establish the index for the specified file, the set of instructions directs the processor to:
acquire information of the specified file;
acquire an identification of a device from which the specified file was uploaded to the storage device; and
establish the index for the specified file based on the file type or based on the identification of the device.

5. The router according to claim 4, wherein the information of the specified file comprises at least one of a path of the file, a hash value of the file, a name of the file, a multipurpose Internet mail extensions MIME type of the file, a creation date of the file, a modification time of the file, an identification of the user device, a size of the file and a thumbnail of the file

6. The router according to claim 1, wherein to provide the classification view of the specified file the processor is further directed to:
receive a file finding request of the specific file sent from the user device; and
send an option of a manner of finding the specific file to the user device, the finding manner comprising a classification finding, a search finding or a directory finding;
receive a selection of the manner of finding from the user device;
find the specified file according to the selected manner of finding; and
send the classification view of the specified file to the user device when the selected manner of finding is the classification finding.

7. The router according to claim 1, wherein the processor is further directed to:
receive an identification of a file classification from the user device;
determine a first plurality of files based on the received identification;
sort the first plurality of files based on the index established for the first plurality of files; and
send an arrangement view of the sorted first plurality of files to the user device, the arrangement view of the first plurality of files comprising at least a name of the first plurality of files.

8. The router according to claim 7, wherein the arrangement view of the first plurality of files further comprises one or more of:
a multipurpose Internet mail extensions MIME type of the first plurality of files, a size of the first plurality of files,
a path of the first plurality of files,
a uniform resource locator URL of the first plurality of files,
a URL of a thumbnail of the first plurality of files, and
a creation time of the first plurality of files.

9. The router according to claim 7, wherein to sort the first plurality of files the processor is further directed to:
sort the first plurality of files according to creation time thereof when the first plurality of files are pictures;
sort the first plurality of files according to names thereof when the first plurality of files are audios;
sort the first plurality of files according to creation time thereof when the first plurality of files are videos; and
sort the first plurality of files according to modification time thereof when the first plurality of files are textual files.

10. The router according to claim 1, wherein, the processor is further directed to:
receive a manner of finding from the user device, the manner of finding comprising classification finding, search finding, or directory finding;
find a second plurality of files based on the index established for the second plurality of files, the second plurality of files being the specified file corresponding to an identification of a device from which the second plurality of files was uploaded, and
send an arrangement view of the second plurality of files to the user device when the finding manner is the search finding, the arrangement view of the second plurality of files comprising at least names of the second plurality of files;
send a directory structure of the second plurality of files to the user device when the finding manner is the directory finding; and
provide the classification view of the second plurality of files to the user device when the finding manner is the classification finding.

11. The router according to claim 1, wherein, the processor is further directed to:
monitor a newly added file in the storage device; and
establish an index for the new added file according to the classification when the new added file is different from other stored files in the storage device.

12. A method for finding a file in a storage device using a router, wherein the router is configured to connect to two or more data lines between a plurality of networks to forward data packets between the plurality of networks, the method comprising:
establishing, by the router, an index for a specified file in the storage device according to a classification; and
providing, by the router, information of the specified file to a user device with a classification view showing a tree-structured classification of the specified file,
wherein the classification comprises classifying a file according to a file type of the file or an identification of a device from which the file was uploaded.

13. The method according to claim 12, wherein the establishing of the index for the specified file comprises:
acquiring information of the specified file;
acquiring the identification of the device from which the specified file was uploaded to the storage device; and
establishing the index for the specified file based on the file type or based on the identification of the device.

14. The method according to claim 12, wherein the information of the specified file comprises at least one of a path of the file, a hash value of the file, a name of the file, a multipurpose Internet mail extensions MIME type of the file, a creation date of the file, a modification time of the file, an identification of the user device, a size of the file and a thumbnail of the file

15. The method according to claim 12, wherein the providing of the classification view of the specified file comprises:
receiving a file finding request of the specific file sent from the user device; and
sending an option of a manner of finding the specific file to the user device, the finding manner comprising a classification finding, a search finding or a directory finding;
receiving a selection of the manner of finding from the user device;
finding the specified file according to the selected manner of finding; and
sending the classification view of the specified file to the user device when the selected manner of finding is the classification finding.

16. The method according to claim 12, further comprising:
receiving, by the router, an identification of a file classification from the user device;
determining, by the router, a first plurality of files based on the received identification;
sorting, by the router, the first plurality of files based on the index established for the first plurality of files; and
sending, by the router, an arrangement view of the sorted first plurality of files to the user device, the arrangement view of the first plurality of files comprising at least a name of the first plurality of files,
wherein the arrangement view of the first plurality of files further comprises one or more of:
a multipurpose Internet mail extensions MIME type of the first plurality of files, a size of the first plurality of files,
a path of the first plurality of files,
a uniform resource locator URL of the first plurality of files,
a URL of a thumbnail of the first plurality of files, and
a creation time of the first plurality of files.

17. The method according to claim 16, wherein sorting the first plurality of files further comprises:
sorting the first plurality of files according to creation time thereof when the first plurality of files are pictures;
sorting the first plurality of files according to names thereof when the first plurality of files are audios;
sorting the first plurality of files according to creation time thereof when the first plurality of files are videos; and
sorting the first plurality of files according to modification time thereof when the first plurality of files are textual files.

18. A non-transitory processor-readable storage medium comprising a set of instructions for directing a router to find a file in a storage device, wherein when executing by the router the set of instructions directs the router to perform acts of:
connecting the router to a storage device;
establishing an index for a specified file in the storage device according to a classification; and
providing information of the specified file to a user device with a classification view showing a tree-structured classification of the specified file,
wherein the user device is in communication with the router and the classification comprises classifying a file according to a file type of the file or an identification of a device from which the file was uploaded.

19. The storage medium according to claim 18, wherein the establishing of the index for the specified file comprises:
acquiring information of the specified file;
acquiring the identification of the device from which the specified file was uploaded to the storage device; and
establishing the index for the specified file based on the file type or based on the identification of the device.

20. The storage medium according to claim 18, wherein the information of the specified file comprises at least one of a path of the file, a hash value of the file, a name of the file, a multipurpose Internet mail extensions MIME type of the file, a creation date of the file, a modification time of the file, an identification of the user device, a size of the file and a thumbnail of the file.
